(19) United States
(12) Patent Application Publication
(10) Pub. No.: US 2026/0046766 A1
(43) Pub. Date: Feb. 12, 2026

(54) Group Signaling for Network Energy Savings

(71) Applicant: TELEFONAKTIEBOLAGET LM ERICSSON (PUBL), Stockholm (SE)

(72) Inventors: Lian ARAUJO, Solna (SE); Sladana JOSILO, Solna (SE); Nianshan SHI, Jarfalla (SE); Ali NADER, Malmo (SE); Sina MALEKI; Andres REIAL, Hollviken (SE)

(21) Appl. No.: 19/100,860

(22) PCT Filed: Aug. 4, 2023
(86) PCT No.: PCT/IB2023/057916

§ 371 Date: Feb. 3, 2025

Related U.S. Application Data
(60) Provisional application No. 63/395,421, filed on Aug. 5, 2022.

(51) Int. Cl. H04W 52/02; H04W 36/36; H04W 76/28

(52) U.S. Cl. CPC H04W 52/0216; H04W 36/362; H04W 76/28

(57) ABSTRACT

Systems and methods for group signaling to enable turning off network resources in a controlled manner to allow for network energy savings are provided. A wireless device is configured with at least one conditional action associated with network energy savings. The wireless device detects an unavailability of network resources associated with a network node, and performs the at least one conditional action associated with network energy savings in response.

### CROSS REFERENCE TO RELATED APPLICATIONS

This application claims the benefit of U.S. Provisional Application No. 63/395,421 filed on Aug. 5, 2022, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system NR will support a diverse set of use cases and a diverse set of deployment scenarios. The later includes deployment at both low frequencies (e.g. 100 s of MHz), similar to LTE today, and very high frequencies (e.g. mm waves in the tens of GHz).

5G is the fifth generation of mobile communications, addressing a wide range of use cases from Enhanced Mobile Broadband (eMBB) to Ultra-Reliable Low-Latency Communications (URLLC) to Massive Machine Type Communications (mMTC). 5G includes the New Radio (NR) access stratum interface and the 5G Core Network (5GC). The NR physical and higher layers are reusing parts of the LTE specification, and to that add needed components when motivated by new use cases.

Energy consumption is a challenge of 5G systems today where a major contributor to the energy consumption is the radio unit of the RAN system. The network power consumption for NR is said to be less compared to LTE because of its lean design (e.g. no CRS and the SSB periodicity is by default 20 ms). However, NR in the current implementation might consume more energy compared to LTE, partly due to higher bandwidths, shorter TTIs and massive number of antennas. This can be evident even at times when cells and beams are lightly loaded or serve no traffic or no users at all. One basic method for saving network energy is to simply turn off a gNB or cell completely when it is seen (or predicted) that there is little or no traffic or even no user in the cell.

### SUMMARY

It is an object of the present disclosure to obviate or mitigate at least one disadvantage of the prior art.

There are provided systems and methods for group signaling to enable turning off network resources in a controlled manner providing for network energy savings.

In a first aspect there is provided a method performed by a wireless device. The wireless device can comprise a radio interface and processing circuitry and be configured to receive, from a network node, a configuration message including at least one conditional action associated with network energy savings. The wireless device detects an unavailability of network resources associated with the network node; and performs the at least one conditional action associated with network energy savings in response to the indication of the unavailability of network resources.

In some embodiments, the configuration message can be one of a radio resource control (RRC) message and/or a Medium Access Control (MAC) control element (CE) message. The configuration message can be received via one of group or cell-wide signaling.

In some embodiments, detecting the unavailability of network resources is in response to receiving, from the network node, an indication of the unavailability of network resources associated with the network node. The indication of the unavailability of network resources can be one of a release message and/or a reconfiguration message. In some embodiments, the indication of the unavailability of network resources further indicates a time window for the unavailability.

In some embodiments, the conditional action associated with network energy savings includes performing a conditional handover to a second network node.

In some embodiments, the conditional action associated with network energy savings includes modifying a discontinuous transmission/discontinuous reception (DTX/DRX) configuration. Modifying can include activation or deactivation of a cell DTX/DRX configuration.

In some embodiments, the conditional action associated with network energy savings includes not triggering a re-establishment with the network node.

In some embodiments, the wireless device is further configured to transmit a request for the network node to cancel and/or modify the unavailability of network resources.

In another aspect, there is provided a method performed by a network node. The network node can comprise a radio interface and processing circuitry and be configured to transmit, to a wireless device, a configuration message including at least one conditional action associated with network energy savings. The network node transmits an indication of an unavailability of network resources associated with the network node.

In some embodiments, the configuration message is one of a RRC message and/or a MAC CE message. The configuration message can be transmitted via one of group or cell-wide signaling.

In some embodiments, the indication of the unavailability of network resources is one of a release message and/or a reconfiguration message. The indication of the unavailability of network resources can further indicate a time window for the unavailability.

In some embodiments, the conditional action associated with network energy savings includes one or more of: performing a conditional handover to a second network node; modifying a DTX/DRX configuration; and/or not triggering a re-establishment with the network node.

In some embodiments, the network node is further configured to determine the unavailability of network resources associated with the network node.

In some embodiments, the network node can further receive a request to cancel and/or modify the indicated unavailability of network resources.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 is an example communication system;

FIG. 2 is an example signaling diagram;

FIG. 3 is a flow chart illustrating a method performed by a wireless device;

FIG. 4 is a flow chart illustrating a method performed by a network node;

FIG. 5 is a block diagram of an example wireless device;

FIG. 6 is a block diagram of an example network node;

FIG. 7 is a block diagram of an example host;

FIG. 8 is a block diagram illustrating an example virtualization environment; and

FIG. 9 is a communication diagram of a host communicating via a network node with a UE.

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

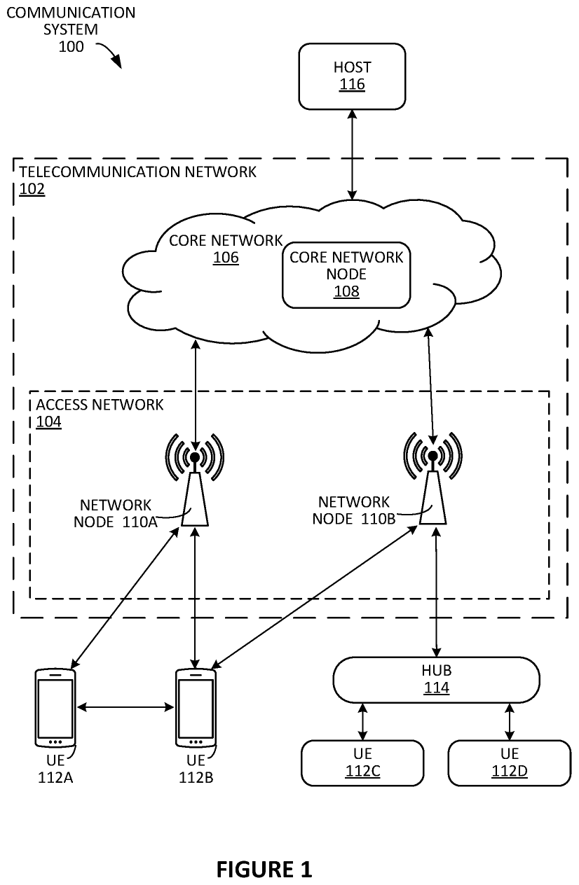

FIG. 1 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

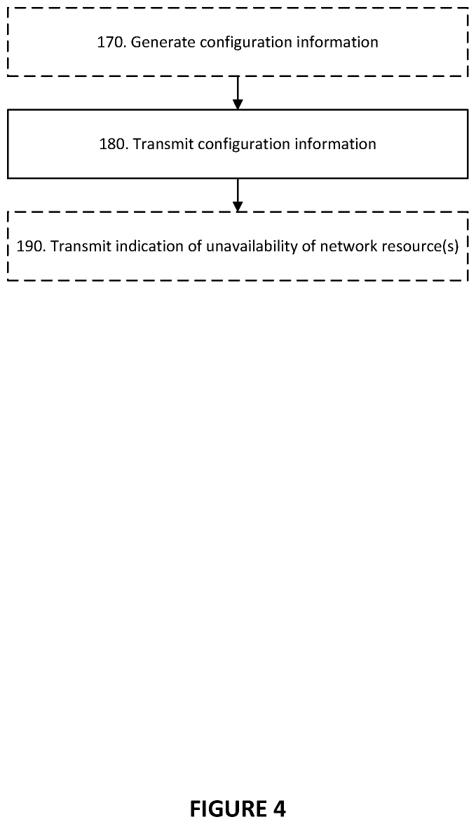

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of energy usage, it is assumed herein that the conventional network may aim to turn off one or more cells for the sake of energy savings. Such an action will affect any UEs being served within the coverage of the affected area. A network node that wants to trigger actions for all UEs (or a group of UEs) that it serves can face different issues depending on the strategy adopted.

One strategy is to simply turn off the cell without sending any information/configuration to the UEs within its coverage area. However, those UEs will not be aware that the node was turned off, but rather assume that they are experiencing poor coverage and hence may attempt to re-establish their connection with this node. This is not a preferred strategy as it may create a poor user experience due to potential sudden service outage

Another strategy is to aim for service continuity and carry out the intended action (e.g. turn-off) in a more controlled/informed manner. The network node may want to trigger mobility for such UEs (e.g. via release and redirect or handover command), but it must send a dedicated RRC message for each of the UEs in connected mode that are served by this node. This strategy requires network resources, excessive energy for the extra transmissions, and slows down the process of the network to turn off.

Even with this approach, idle UEs will not be aware that the network node was turned off and may experience an outage or could potentially be in the process of attempting to connect with this node while the gNB is about to turn off.

Similarly, as above, if the network wants to activate/deactivate/release SCells (or an SCG) for multiple UEs, it must send a MAC CE for each of those UEs.

As an initial note, the terminology “network energy savings” will be used herein to refer to any feature used for network energy/power saving purposes (even if not initially designed for this purpose, e.g. a conditional handover).

Some embodiments described herein are directed to methods for a UE to be configured with conditional actions related to network energy savings, comprising one or more of:
Receiving a configuration message, or a set of configuration messages (each being applicable to different UE types, and/or UEs of various capabilities, and/or applicable to UEs in different parts of the area) containing conditional reconfiguration.
Receiving a release message, or a set of release messages (each being applicable to different UE types, and/or UEs of various capabilities, and/or applicable to UEs in different parts of the area) containing conditional release and redirect.
The UEs in the area (e.g. cell(s)) can be informed that some/all resources (e.g. complete cell, or some parts corresponding to SSBs, or transmission points, etc.) of the area are about to be turned off.
Further, optionally, the UEs can be informed that the turning off will occur after a specific time so that UEs can prepare for said provided configuration (e.g., search for new carriers/cells) while still being served by current cell.
Further, optionally, allowing the UEs within a specific time window to request to not turn off the node in case said provided configuration cannot alleviate service outage.

In some embodiments, a UE can be configured with conditional actions related to network energy savings. The actions can comprise any of:
a) Applying an RRC configuration, e.g., for handover or release and redirect towards a target cell/node;
b) Changing UE active BWP (including changing the active BWP to/from a dormant BWP);
c) Change in the status of one or more sub gNBs, e.g., turning OFF/ON TRPs;
d) Change in the transmit power of gNB;
e) Change in the (max) number of ports used for data/control channel/RSs;
f) Change in a C-DRX configuration for a group of UEs;
g) Change in a DTX/DRX scheme associated with the gNB;
h) Add/release/deactivate serving cells;
i) Start/stop measuring on a target frequency;
j) Add/release/deactivate a Secondary Cell Group (SCG) configuration;

In some embodiments, a UE can be configured with conditional actions related to network energy savings. The trigger condition(s) can comprise any of:
a) Once the UE detects RLF for a cell group and measurement conditions of a target frequency are met;
b) Do not trigger re-establishment due to failure (since the node the UE was served by may have turned off)
c) Do not trigger a new connection from Idle/inactive
d) Perform UE report based on conditions related to network energy savings:
If the UE concludes from its configured conditions that RLF was detected for a network node that has turned off, the UE can include this information within UE information response (if requested by the network);
The UE can include a new field in its RLF report; or refrain from including a new entry in the report if the UE concludes that the RLF was triggered due to network turning off.
e) Whether the UE contains certain service, or service with certain QoS requirements. When the condition is met, UE would perform handover and leave the previous serving cell. This is to assist the network to collect certain service, e.g., low QoS service in one node, e.g. the node provides coverage, and be able to switch off the capacity nodes, or make them possible to sleep.
f) The handover condition is met when UE is indicated via low layer, e.g. by MAC CE from the current serving cell. UE should perform handover according to Conditional Handover (CHO) procedure, knowing that the current serving cell may soon be switched off or goes to sleep.

In some embodiments, a UE configured with conditional actions related to network energy savings can be configured in different ways:
a) Dedicated configuration with execution condition:
i. Configurations for conditional actions provided ahead of time via:
individually via RRC
individually via MAC CE
cell-wide in SIB
cell-wide via paging framework (as special-purpose paging PDSCH payload)
ii. Group-common (cell-wide) conditional action triggers provided via:
Paging DCI/paging short message

The short message can for example indicate/trigger (cell turn off is imminent, and the configurations are in a SIB), be via SI update-like framework, and/or be via ETWS-like framework.
Group-common DCI
“Group common” MAC CE
b) Configuration together with immediate trigger:
cell-wide via paging framework (as special-purpose paging PDSCH payload)
c) Either of the methods above, where multiple configurations are provided to the UE, with a configuration being applicable to one or more of:
UEs in a specific area of the cell (e.g., within coverage of certain SSBs or beams),
UEs of certain capability.
UEs of certain type (e.g., RedCap, eMBB)
UEs currently active with a specific service/service type (e.g., low latency, voice, XR, etc.)
UEs served by specific TRPs or sub gNBs

In some embodiments, the network can configure a UE with conditional actions related to network energy savings, which may further comprise:
a) Transmitting to another node an indication that a network node will turn off;
Such indication can be from a source node to a target node, including MN and SN nodes;
It can be included within handover preparation message, or CG-configInfo message;
b) The network node can indicate to the UE that it is planning to turn off; the indication may contain information about the time at which the network node plans to turn off and information about the time at which the network node plans to turn on again.
The indication can be performed via DCI or MAC CE; e.g., a bitfield in existing DCIs or a new DCI specifically designed for network energy savings purposes can be used to transmit the indication. The DCI can be associated with a group common or cell specific RNTI to target a group of UEs. To use DCI or MAC CE signaling can also depend on the specific action to be taken by the NW, e.g., for a BWP change, a DCI mechanism can be used, but for letting the UE know that a cell is going to be turned OFF, a more robust approach such as MAC CE can be used.
The indication can be in the form of a changed transmitted signal pattern, e.g., a specific sequence included in a RS. For example, instead of the regular SSB, the gNB indicates to the UEs that it has turned off by transmitting another type of reference signal, such as an SSB with specific characteristics (e.g., without the PBCH part) or a newly introduced type of a discovery signal.
The indication can be included as part of an existing SIB, or a new SIB specifically designed for network energy savings purposes.
Irrespective of the indication, the network can configure the UE with an application delay, i.e., a delay from the time the indication is transmitted to the UE/or received by the UE, and the time that the action will be implemented by the network. The application delay can be explicitly indicated by the NW or be based on a default value.
c) The network node may further allow some (e.g., a specific group identified via a common identity, specific type of UEs, UEs with certain capability, UEs in certain area of the cell, UEs currently involved in certain specific services) or all of the UEs within a specific time window to request to not turn off the node in case said provided configuration cannot alleviate service outage. Said request may be provided via a specific preamble, an UL MAC-CE, or a dedicated RRC message.
d) To release and re-direct a group of UEs: for service such as IMS services, it is often up to NG-RAN node to decide if to service the IMS service, or to perform Handover, release with redirect. When the network is going to an energy saving phase, on some occasions, it would be most efficient to inform the UE and group of UEs to perform “release with redirect”, if they intend to access the network in IMS service. This can be done, for example, by inform the UE/group of UEs in the Cell with a SIB broadcast message. Some assistance information can be provided to aid the UE to find the right network to camp on. Such information may also be possible to provide to the UE during a release procedure.

Accordingly, a network node can trigger UE actions for multiple UEs without requiring sending multiple RRC messages (or other NW commands) in a short time to each UE. Group signaling can be beneficial in scenarios in which multiple UEs behave in a similar way, i.e., as a group. An example of this scenario is the case when there is a correlation in the mobility patterns of multiple UEs, e.g., multiple collocated UEs in the same train or on the highway moving in the same direction. Another example where group signaling can be beneficial is the case of multiple UEs located in the same area during the same time interval (e.g., a business center) or permanently (e.g., a static sensor network).

Furthermore, some embodiments enable the system to turn off a cell in a controlled manner and allow for UEs that cannot conform to the provided configuration to inform the NW and thereby avoid outage.

Some embodiments can help ensure backward compatibility. For example, the UEs that do not support the described solutions can still be contacted through dedicated signaling.

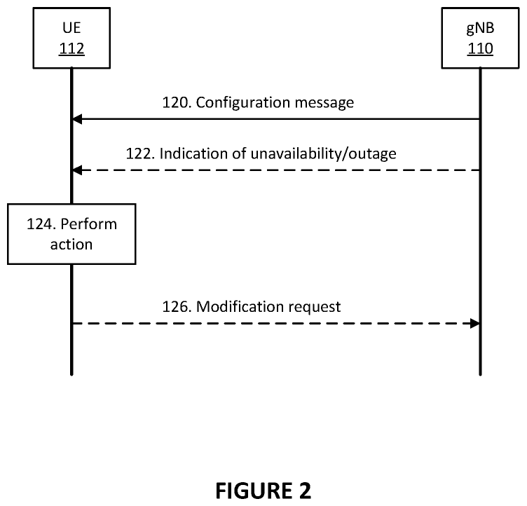

FIG. 2 is an example signaling diagram. gNB 110 transmits a configuration message (120) to UE 112. UE 112 can be configured with one or more conditional actions related to network energy savings. Optionally, gNB 110 transmits an indication (122) of an unavailability or outage of an access node/gNB/cell/network resource(s). The indication may be associated with a conditional reconfiguration and/or release related to indicated outage. UE 112 performs an action (124) related to network energy savings. Optionally, UE 112 can transmit a request (126) to cancel and/or modify the indicated unavailability/outage.

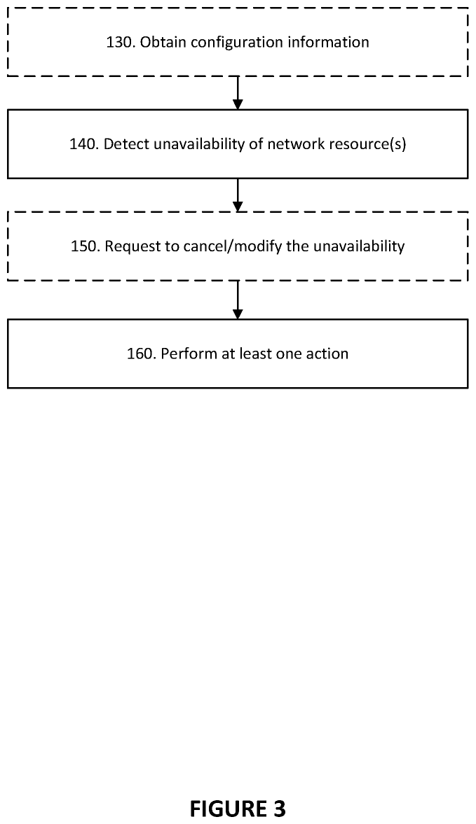

FIG. 3 is a flow chart illustrating a method which can be performed in a wireless device, such as a UE 112 as described herein. The method can include:

Step 130: The wireless device can receive configuration information from a network node, such as access node 110. The configuration information can include one or more conditional actions and/or triggers related to network energy savings. In some embodiments, the configuration information can be received via dedicated signaling (e.g. RRC, MAC CE, etc. messages). In other embodiments, the configuration information can be received via group or cell-wide signaling (e.g. SIB, paging, group common DCI or MAC CE, etc.).

Step 140: The wireless device detects an unavailability of network resources associated with the network node. Optionally, the wireless device can receive an indication associated with an unavailability or outage of network resources, such as an access node/gNB/cell/network, and detect the unavailability in accordance with the received indication. The indication can be a release or reconfiguration message. The indication can be a conditional release or conditional reconfiguration message. In some embodiments, the indication can include an indication of a time window for the unavailability/outage. In some embodiments, the indication can be received via group or cell-wide signaling (e.g. SIB, paging, group common DCI or MAC CE, etc.). In other embodiments, the indication can be in the form of a changed received signal pattern. In some embodiments, the indication can further include assistance information for the UE. In some embodiments, the wireless device can detect an unavailability of network resources without receiving an explicit indication from the network.

Step 150: Optionally, the wireless device can transmit a request (e.g. to the network node) to cancel and/or modify the detected unavailability/outage.

Step 160: The wireless device performs at least one action related to network energy savings in accordance with the detected/indicated unavailability of network resources and/or the configuration information. The action(s) can include applying or changing a configuration (such as a handover or release), not triggering a re-establishment or new connection with the unavailable network resource(s), and/or other actions as described in the various embodiments herein. In some embodiments, the wireless device can transmit, to another node, an indication that the network node will turn off.

It will be appreciated that one or more of the above steps can be performed simultaneously and/or in a different order. Also, steps illustrated in dashed lines are optional and can be omitted in some embodiments.

FIG. 4 is a flow chart illustrating a method which can be performed by a network node such as an access node (e.g. base station/gNB 110) as described herein. The method can include:

Step 170: The network node generates configuration information. The configuration information can include one or more configurations (e.g. triggers and/or actions) for a UE related to network energy savings. The configuration information can be applicable to one or more specific UEs based on their UE type, UE capabilities, UE group, and/or location in the network. The configuration information can include information related to conditional release and/or redirect of the UE's network connection.

Step 180: The network node transmits the generated configuration information. In some embodiments, the configuration information can be transmitted via dedicated signaling (e.g. RRC, MAC CE, etc. messages). In other embodiments, the configuration information can be transmitted via group or cell-wide signaling (e.g. SIB, paging, group common DCI or MAC CE, etc.).

Step 190: The network node transmits an indication associated with an unavailability or outage of network resources, such as an access node/gNB/cell/network. For example, this can include informing one or more UEs in an area (e.g. a cell) that at least some network resources will be turned off and/or unavailable. In some embodiments, the indication is transmitted in response to determining that an outage of some network resource(s) will occur. The determination can be made in response to receiving signaling from another network node. In some embodiments, the indication can include a time window for the unavailability/outage. In some embodiments, the indication can be transmitted via group or cell-wide signaling (e.g. SIB, paging, group common DCI or MAC CE, etc.). In other embodiments, the indication can be in the form of a changed transmitted signal pattern. In some embodiments, the indication can further include assistance information for the UE.

In some embodiments, the network node can further receive a request to cancel and/or modify the indicated unavailability/outage from a wireless device. The network node can determine whether to cancel/modify the outage or to continue with the outage as planned.

It will be appreciated that one or more of the above steps can be performed simultaneously and/or in a different order. Also, steps illustrated in dashed lines are optional and can be omitted in some embodiments.

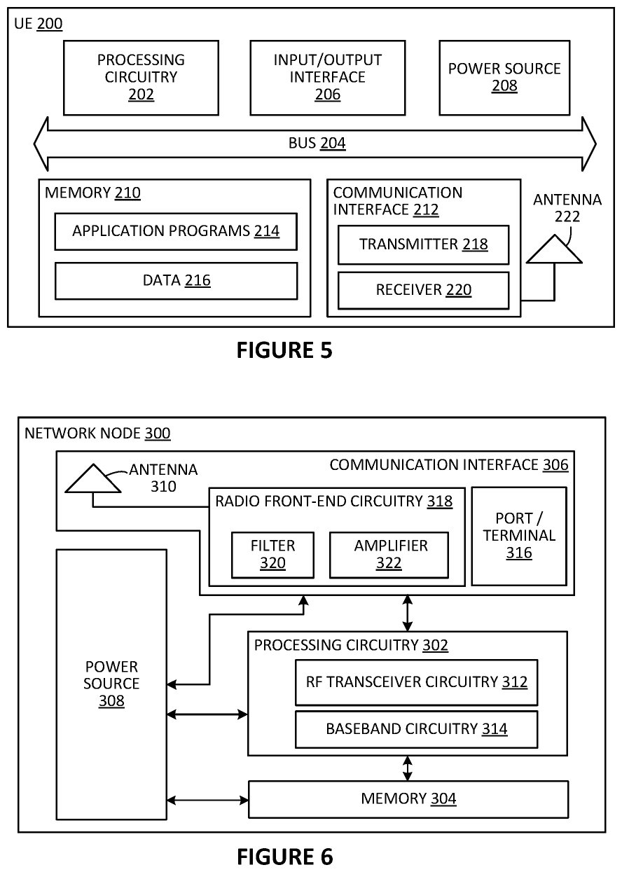

FIG. 5 shows a UE 200, which may be an embodiment of the UE 112 of FIG. 1 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 300, which may be an embodiment of the access node 110 or the core network node 108 of FIG. 1, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

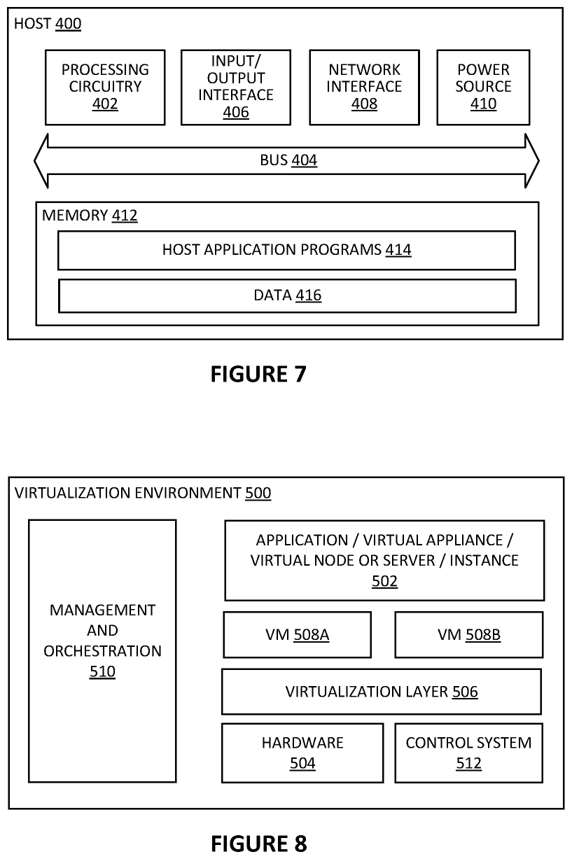

FIG. 7 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 5 and 6, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

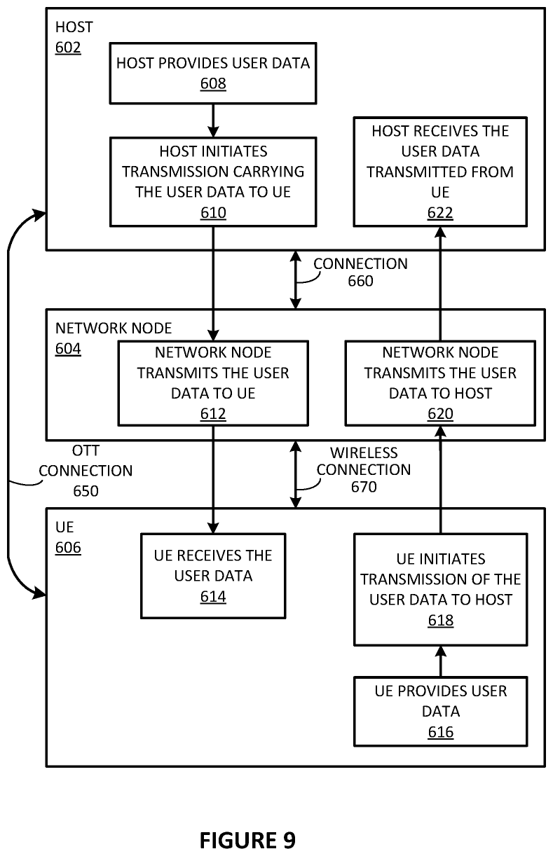

FIG. 9 shows a communication diagram of a host 602 communicating via a network node 604 with a UE 606 over a partially wireless connection in accordance with some embodiments. Example implementations, in accordance with various embodiments, of the UE (such as a UE 112A of FIG. 1 and/or UE 200 of FIG. 5), network node (such as network node 110A of FIG. 1 and/or network node 300 of FIG. 6), and host (such as host 116 of FIG. 1 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1x RTT CDMA2000 1x Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
   Reference Signal Received Power
RSRQ Reference Signal Received Quality OR
   Reference Symbol Received Quality
RSSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a wireless device, the method comprising:
receiving, from a network node, a configuration message including at least one conditional action associated with network energy savings;
detecting an unavailability of network resources associated with the network node; and
performing the at least one conditional action associated with network energy savings in response to the indication of the unavailability of network resources.

2. The method of claim 1, wherein the configuration message is one of: a radio resource control (RRC) message, and a Medium Access Control (MAC) control element (CE) message.

3. The method of any one of claims 1 to 2, wherein the configuration message is received via one of group or cell-wide signaling.

4. The method of any one of claims 1 to 3, wherein detecting the unavailability of network resources is in response to receiving, from the network node, an indication of the unavailability of network resources associated with the network node.

5. The method of claim 4, wherein the indication of the unavailability of network resources is one of: a release message, and a reconfiguration message.

6. The method of any one of claims 4 to 5, wherein the indication of the unavailability of network resources further indicates a time window for the unavailability.

7. The method of any one of claims 1 to 6, wherein the conditional action associated with network energy savings includes performing a conditional handover to a second network node.

8. The method of any one of claims 1 to 7, wherein the conditional action associated with network energy savings includes modifying a discontinuous transmission/discontinuous reception (DTX/DRX) configuration.

9. The method of claim 8, wherein modifying includes activation or deactivation of a cell DTX/DRX configuration.

10. The method of any one of claims 1 to 9, wherein the conditional action associated with network energy savings includes not triggering a re-establishment with the network node.

11. The method of any one of claims 1 to 10, further comprising, transmitting a request for the network node to cancel and/or modify the unavailability of network resources.

12. A wireless device comprising a radio interface and processing circuitry configured to:
receive, from a network node, a configuration message including at least one conditional action associated with network energy savings;
detect an unavailability of network resources associated with the network node; and
perform the at least one conditional action associated with network energy savings in response to the indication of the unavailability of network resources.

13. The wireless device of claim 12, wherein the configuration message is one of: a RRC message, and a MAC CE message.

14. The wireless device of any one of claims 12 to 13, wherein the configuration message is received via one of group or cell-wide signaling.

15. The wireless device of any one of claims 12 to 14, wherein detecting the unavailability of network resources is in response to receiving, from the network node, an indication of the unavailability of network resources associated with the network node.

16. The wireless device of claim 15, wherein the indication of the unavailability of network resources is one of: a release message, and a reconfiguration message.

17. The wireless device of any one of claims 15 to 16, wherein the indication of the unavailability of network resources further indicates a time window for the unavailability.

18. The wireless device of any one of claims 12 to 17, wherein the conditional action associated with network energy savings includes performing a conditional handover to a second network node.

19. The wireless device of any one of claims 12 to 18, wherein the conditional action associated with network energy savings includes modifying a discontinuous transmission/discontinuous reception (DTX/DRX) configuration.

20. The wireless device of claim 19, wherein modifying includes activation or deactivation of a cell DTX/DRX configuration.

21. The wireless device of any one of claims 12 to 20, wherein the conditional action associated with network energy savings includes not triggering a re-establishment with the network node.

22. The wireless device of any one of claims 12 to 21, further configured to transmit a request for the network node to cancel and/or modify the unavailability of network resources.

23. A method performed by a network node, the method comprising:
transmitting, to a wireless device, a configuration message including at least one conditional action associated with network energy savings; and
transmitting an indication of an unavailability of network resources associated with the network node.

24. The method of claim 23, wherein the configuration message is one of: a RRC message, and a MAC CE message.

25. The method of any one of claims 23 to 24, wherein the configuration message is transmitted via one of group or cell-wide signaling.

26. The method of any one of claims 23 to 25, wherein the indication of the unavailability of network resources is one of: a release message, and a reconfiguration message.

27. The method of any one of claims 23 to 26, wherein the indication of the unavailability of network resources further indicates a time window for the unavailability.

28. The method of any one of claims 23 to 27, wherein the conditional action associated with network energy savings includes one or more of: performing a conditional handover to a second network node; modifying a discontinuous transmission/discontinuous reception (DTX/DRX) configuration; and not triggering a re-establishment with the network node.

29. The method of any one of claims 23 to 28, further comprising, determining the unavailability of network resources associated with the network node.

30. The method of any one of claims 23 to 29, further comprising, receiving a request to cancel and/or modify the indicated unavailability of network resources.

31. A network node comprising a radio interface and processing circuitry configured to:
transmitting, to a wireless device, a configuration message including at least one conditional action associated with network energy savings; and
transmitting an indication of an unavailability of network resources associated with the network node.

32. The network node of claim 31, wherein the configuration message is one of: a RRC message, and a MAC CE message.

33. The network node of any one of claims 31 to 32, wherein the configuration message is transmitted via one of group or cell-wide signaling.

34. The network node of any one of claims 31 to 33, wherein the indication of the unavailability of network resources is one of: a release message, and a reconfiguration message.

35. The network node of any one of claims 31 to 34, wherein the indication of the unavailability of network resources further indicates a time window for the unavailability.

36. The network node of any one of claims 31 to 35, wherein the conditional action associated with network energy savings includes one or more of: performing a conditional handover to a second network node; modifying a discontinuous transmission/discontinuous reception (DTX/DRX) configuration; and not triggering a re-establishment with the network node.

37. The network node of any one of claims 31 to 36, further configured to determine the unavailability of network resources associated with the network node.

38. The network node of any one of claims 31 to 37, further configured to receive a request to cancel and/or modify the indicated unavailability of network resources.
